(19) United States
(12) Patent Application Publication
(10) Pub. No.: US 2026/0183885 A1
(43) Pub. Date: Jul. 2, 2026

(54) CLAMPING FORCE SENSING APPARATUS

(71) Applicant: INDUSTRIAL TECHNOLOGY RESEARCH INSTITUTE, Hsinchu (TW)

(72) Inventors: Yung-Hsiang CHANG, Tainan City (TW); Che-Kai YEH, Tainan City (TW); Chien-Nan YEH, Tainan City (TW); Chao-Ta HUANG, Hsinchu City (TW)

(73) Assignee: INDUSTRIAL TECHNOLOGY RESEARCH INSTITUTE, Hsinchu (TW)

(21) Appl. No.: 19/301,039

(22) Filed: Aug. 15, 2025

(30) Foreign Application Priority Data
Dec. 30, 2024 (TW) 113151428

(51) Int. Cl. B23Q 17/00; G01L 5/00

(52) U.S. Cl. CPC B23Q 17/005; G01L 5/009

(57) ABSTRACT

A clamping force sensing apparatus includes a body, a plurality of strain sensors and a plurality of chucks. The body has two first through holes, a second through hole and a peripheral side surface. The first through holes and the second through hole penetrate the body along a penetrating axial direction parallel to a rotation axis, the rotation axis passes through a center of mass of the body and a centroid of the peripheral side surface. A first inner surface of the second through hole is closer to the first through holes than a second inner surface of the second through hole. In the penetrating axial direction, a first projecting area of each of the first through holes is less than a second projecting area of the second through hole. The strain sensors are disposed on the body. The chucks are fixed to the body.

This non-provisional application claims priority under 35 U.S.C. § 119(a) on Taiwan application Serial No. 113151428 filed on Dec. 30, 2024, the entire contents of which are hereby incorporated by reference.

### TECHNICAL FIELD

The disclosure relates to a sensing apparatus, and in particular to a clamping force sensing apparatus.

### BACKGROUND

In the field of mechanical processing, it is often necessary to use machine tool fixtures to clamp workpieces or cutters for rotation in order to process the workpieces. Controlling the accuracy and stability of the clamping force of the machine tool fixtures is one of key factors in improving the precision of production line processing.

Therefore, to ensure the processing precision of the production line, it is often necessary to use clamping force sensors to calibrate machine tools. Machine tool fixtures come with varying numbers of jaws, with common types being double-jaw and triple-jaw models.

Currently, while embedded sensors are available in the industry, their flexibility of application is relatively limited. Moreover, different sensor needs to be replaced for machine tool fixtures with different numbers of jaws. This reduces the willingness of on-site personnel to use them.

### SUMMARY

The objective of this disclosure is to provide a clamping force sensing apparatus, which may be generally applied with different number of jaws.

One embodiment of the disclosure provides a clamping force sensing apparatus including a body, a plurality of strain sensors and a plurality of chucks. The body includes two first through holes, a second through hole and a peripheral side surface. The first through holes and the second through hole penetrate the body along a penetrating axial direction parallel to a rotation axis, the rotation axis passes through a center of mass of the body and a centroid of the peripheral side surface. An inner surface of the second through hole is formed by joining a first inner surface and a second inner surface. The first inner surface is closer to the first through holes than the second inner surface. A first projecting area of each of the first through holes in the penetrating axial direction is less than a second projecting area of the second through hole in the penetrating axial direction. The strain sensors are disposed on the body. At least one of the strain sensors is located between one of the first through holes and the first inner surface. At least another of the strain sensors is located between the other of the first through holes and the first inner surface. The chucks are fixed to the body.

One embodiment of the disclosure provides a clamping force sensing apparatus including a body, a plurality of strain sensors and a plurality of chucks. The body includes an annular part, a T-shaped part and a curved part. The T-shaped part is disposed inside the annular part. The T-shaped part has a trunk region and a branch region. The trunk region has two first ends. The branch region extends from the trunk region and has a second end. The first ends and the second end are respectively connected to the annular part. Two first through holes are formed by joining the trunk region, the branch region and the annular part. The two first through holes are respectively located at two opposite sides of the branch region. The curved part is disposed inside the annular part. The curved part is curved along the annular part and connected to the annular part. The curved part has two third ends. The third ends are connected to the trunk region and respectively adjacent to the first ends. A second through hole is formed by the curved part and the trunk region. The first through holes and the second through hole penetrate the body along a penetrating axial direction parallel to a rotation axis of the body, the rotation axis passes through a center of mass of the body and a centroid of the annular part. The strain sensors are disposed on the trunk region. The chucks are fixed to the annular part.

One embodiment of the disclosure provides a clamping force sensing apparatus including a body, a plurality of strain sensors and a plurality of chucks. The body is a column. The body has a peripheral side surface, an upper surface and a lower surface and has a first load-bearing point, a second load-bearing point, a third load-bearing point and a fourth load-bearing point located on the peripheral side surface. The strain sensors are disposed on the upper surface or the lower surface of the body. The chucks are fixed to at least two of the first load-bearing point, the second load-bearing point, the third load-bearing point and the fourth load-bearing point of the body. A rotation axis of the body passes through a centroid of the peripheral side surface from the upper surface to the lower surface. A central angle defined by the centroid, the first load-bearing point and the second load-bearing point with respect to the rotation axis is 180 degrees. A central angle defined by the centroid, any two of the first load-bearing point, the third load-bearing point and the fourth load-bearing point with respect to the rotation axis is 120 degrees. A two-point clamping strain value is an average value of strain values output by the strain sensors under a radial force applied to each of the first load-bearing point and the second load-bearing point. A three-point clamping strain value is another average value of the strain values output by the plurality of strain sensors under another radial force applied to each of the first load-bearing point, the third load-bearing point and the fourth load-bearing point. A magnitude of the radial force is equal to a magnitude of the another radial force. The body has a plurality of through holes penetrating the body from the upper surface to the lower surface along a penetrating axial direction parallel to the rotation axis, the through holes are configured such that the rotation axis passes through a center of mass of the body, and a difference between the two-point clamping strain value and the three-point clamping strain value is less than a predetermined value.

According to the clamping force sensing apparatus as discussed in the above embodiments, by means of the configuration of the through holes in the body and the configuration of the four load-bearing points according to the central angles whether the clamping force sensing apparatus measures the clamping force of the triple-jaw clamp or the clamping force of the double-jaw clamp, the radial force applied to the first load-bearing point may be transmitted to the strain sensors through the T-shaped part, and the radial force applied to the second load-bearing point, the radial force applied to the third load-bearing point and the radial force applied to the fourth load-bearing point all pass through the curved part and to bypass the second through hole so as to reach the strain sensors through the T-shaped part. Therefore, the difference between the two-point clamping strain value and the three-point clamping strain value of the clamping force sensing apparatus is less than the predetermined value. Since the difference between the two-point clamping strain value and the three-point clamping strain value is small enough, the clamping force sensing apparatus may be applied to measure the clamping force of different types, including the clamping force of the triple-jaw clamp and the clamping force of the double-jaw clamp, by calibrating the measured strain value.

The above descriptions in the summary and the following detailed descriptions are used to demonstrate and explain the spirit and principle of the disclosure and provide a further explanation of the scope of the claims of the disclosure.

### BRIEF DESCRIPTION OF THE DRAWINGS

The disclosure will become better understood from the detailed description given hereinbelow and the accompanying drawings which are given by way of illustration only and thus are not intending to limit the disclosure and wherein:

FIG. 1 illustrates a schematic three-dimensional view of a triple-jaw clamp using a clamping force sensing apparatus according to one embodiment of the disclosure;

FIG. 2 illustrates a schematic three-dimensional view of the clamping force sensing apparatus in FIG. 1;

FIG. 3 illustrates a schematic three-dimensional exploded view of the clamping force sensing apparatus in FIG. 2;

FIG. 4A to FIG. 4D illustrate schematic rear views of a portion of the clamping force sensing apparatus in FIG. 3;

FIG. 5 illustrates a schematic rear view of a portion of the clamping force sensing apparatus in FIG. 3;

FIG. 6 illustrates a schematic three-dimensional view of a double-jaw clamp using a clamping force sensing apparatus according to another embodiment of the disclosure;

FIG. 7 illustrates a schematic three-dimensional view of the clamping force sensing apparatus in FIG. 6; and

FIG. 8 illustrate a schematic rear view of a portion of the clamping force sensing apparatus in FIG. 7.

### DETAILED DESCRIPTION

Features and advantages of embodiments of the disclosure are described in the following detailed description, it allows a person skilled in the art to understand the technical contents of the embodiments of the disclosure and implement them. Based on the disclosure, the claims, and the drawings, a person skilled in the art can easily comprehend the purposes of the advantages of the disclosure. The following embodiments are further illustrating the perspective of the disclosure, but not intending to limit the scope of the disclosure in any way.

The drawings may not be drawn to actual size, proportions, or angles, some exaggerations may be necessary in order to emphasize basic structural relationships, while some are simplified for clarity of understanding, but the disclosure is not limited thereto. Various modifications may be made without departing from the spirit of the disclosure. In addition, the spatially relative terms, such as “up”, “top”, “above”, “down”, “low”, “left”, “right”, “front”, “rear”, and “back” and the like, may be used herein for ease of description to describe the relationship of one element or feature to another element(s) of feature(s) as illustrated in the drawings. It will be understood that the spatially relative terms are intended to encompass orientations of the element or feature but not intended to limit the disclosure.

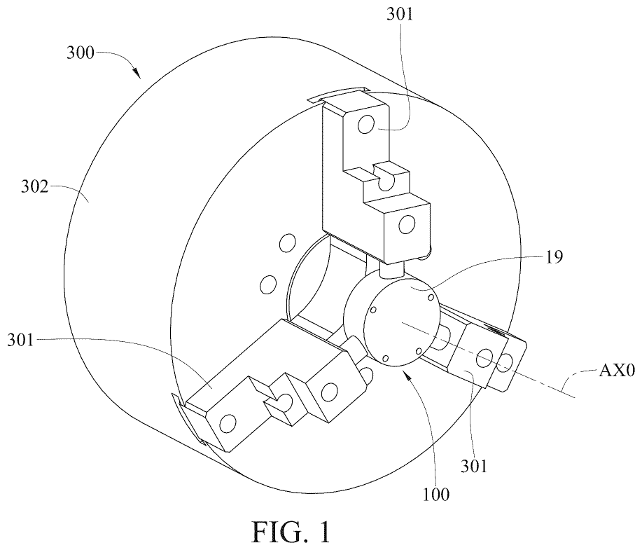

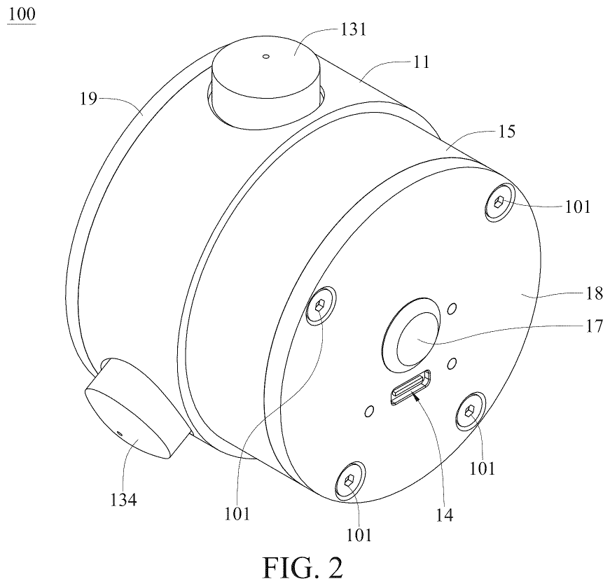

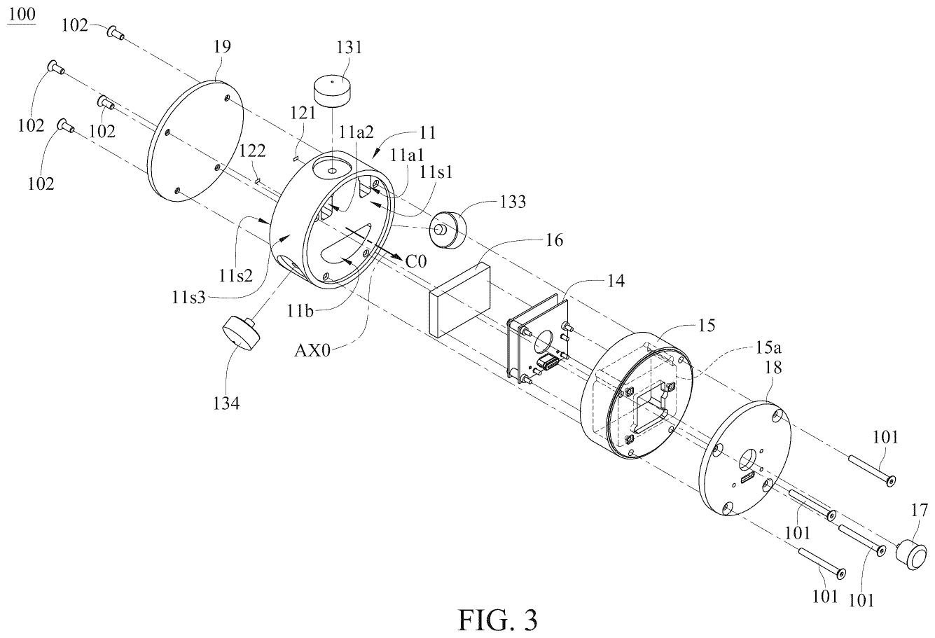

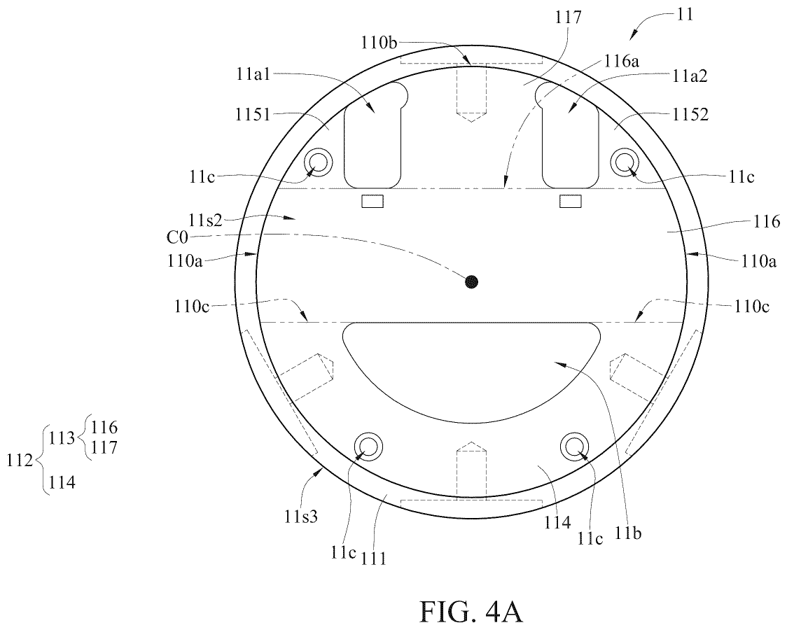

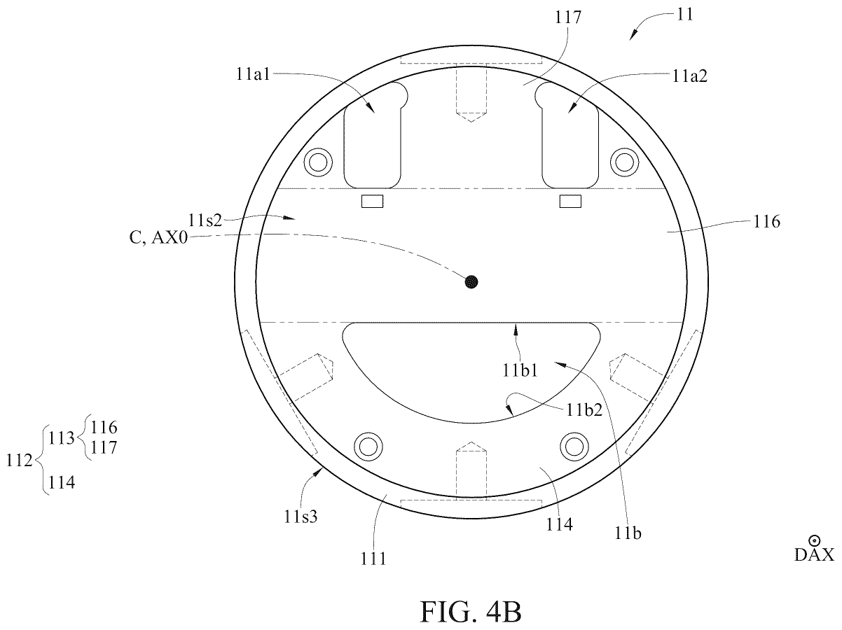

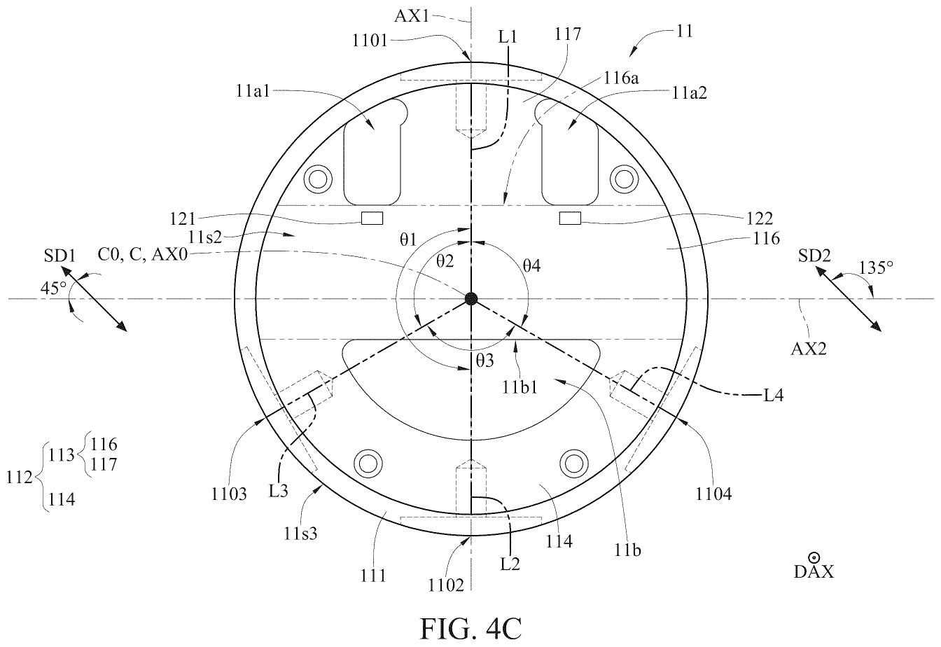

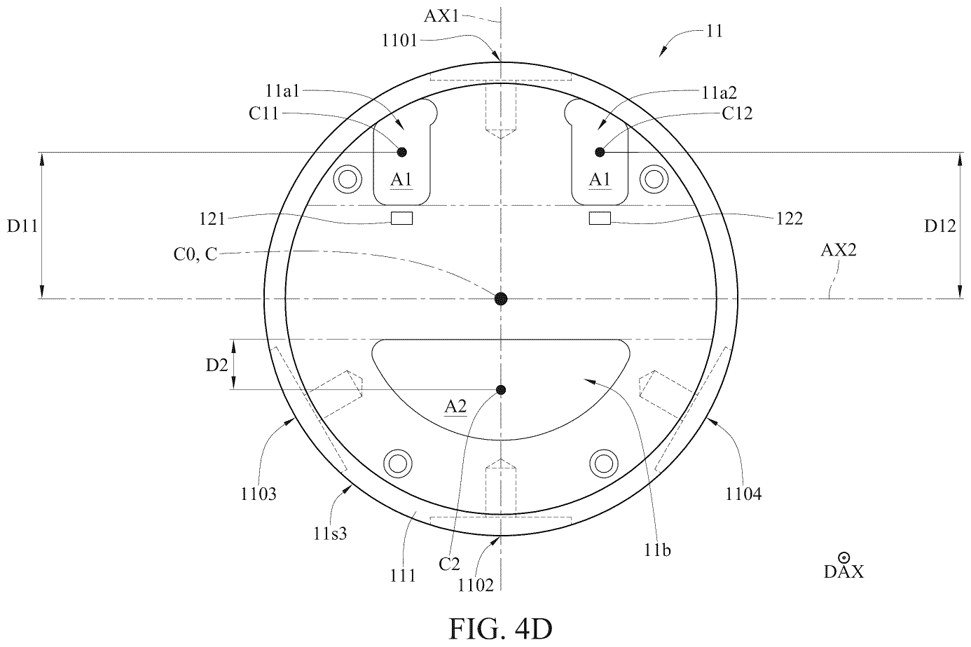

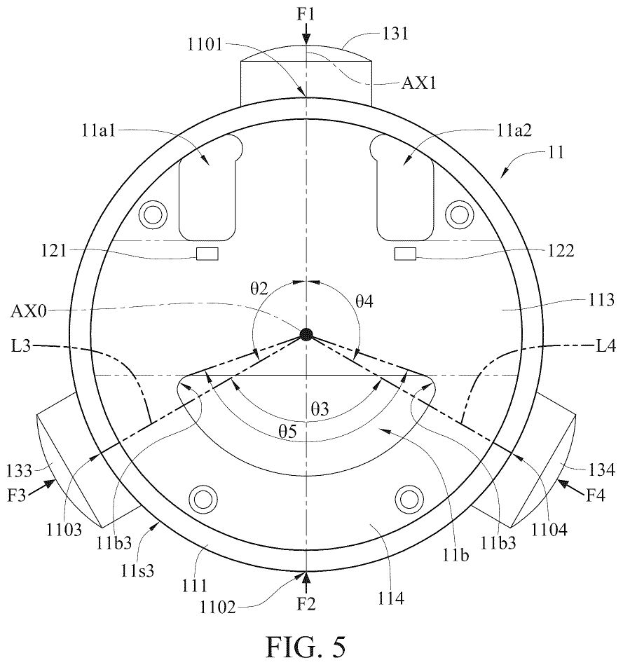

Please refer to FIG. 1 to FIG. 5. FIG. 1 illustrates a schematic three-dimensional view of a triple-jaw clamp using a clamping force sensing apparatus according to one embodiment of the disclosure. FIG. 2 illustrates a schematic three-dimensional view of the clamping force sensing apparatus in FIG. 1. FIG. 3 illustrates a schematic three-dimensional exploded view of the clamping force sensing apparatus in FIG. 2. FIG. 4A to FIG. 4D illustrate schematic rear views of a portion of the clamping force sensing apparatus in FIG. 3. FIG. 5 illustrates a schematic rear view of a portion of the clamping force sensing apparatus in FIG. 3.

As shown in FIG. 1, the triple-jaw clamp 300 includes three jaws 301 and a chuck plate 302. The chuck plate 302 has a rotation axis AX0. The jaws 301 may be movably disposed on the chuck plate 302 and may be switched between a state closer to or a state farther from the rotation axis AX0. When a clamping force of the triple-jaw clamp 300 is to be measured, the clamping force sensing apparatus 100 is placed among the three jaws 301 and clamped by the three jaws 301. In FIG. 1, a back plate 19 of the clamping force sensing apparatus 100 may be faced away from the chuck plate 302, but the disclosure is not limited thereto. In other embodiments, the back plate 19 of the clamping force sensing apparatus 100 may be faced to the chuck plate 302.

As shown in FIG. 2 and FIG. 3, in this embodiment, the clamping force sensing apparatus 100 includes a body 11, two strain sensors 121, 122 and three chucks 131, 133, 134. The clamping force sensing apparatus 100 may further include a circuit module 14, a circuit container 15, a power source 16, a switch 17, a front plate 18, a back plate 19, a plurality of first fixing components 101 and a plurality of second fixing components 102.

As shown in FIG. 3 and FIG. 4A, in this embodiment, a shape of the body 11 is substantially a cylinder (a circular column). The body 11 has an upper surface 11s1 and a lower surface 11s2 opposite to each other and has a peripheral side surface 11s3. The body 11 includes an annular part 111 and a central part 112. The annular part 111 is a circular ring with a ring center C0, and the ring center C0 is a centroid of the annular part 111 or a centroid of the peripheral side surface 11s3. In another embodiment, the body 11 is an equilateral polygonal column with a peripheral side surface, and the peripheral side surface has a centroid. The central part 112 is disposed inside the annular part 111. The central part 112 includes a T-shaped part 113 and a curved part 114 and further includes two fixing parts 1151, 1152.

The T-shaped part 113 is disposed inside the annular part 111. The T-shaped part 113 has two first ends 110a and a second end 110b. The T-shaped part 113 has a trunk region 116 and a branch region 117. The trunk region 116 has the first ends 110a facing away from each other. The branch region 117 extends from a surface 116a of the trunk region 116 and has the second end 110b. The first ends 110a and the second end 110b are connected to the annular part 111. The fixing parts 1151, 1152 are connected to the trunk region 116 and respectively adjacent to the first ends 110a. Two first through holes 11a1, 11a2 are formed by joining the trunk region 116, the branch region 117 and the annular part 111. The first through holes 11a1, 11a2 are respectively located at opposite two sides of the branch region 117. The first through hole 11a1 is formed by joining the annular part 111, the trunk region 116, the branch region 117 and the fixing part 1151. The first through hole 11a2 is formed by joining the annular part 111, the trunk region 116, the branch region 117 and the fixing part 1152.

The curved part 114 is disposed inside the annular part 111. The curved part 114 is curved along the annular part 111 and connected to the annular part 111. The curved part 114 has two third ends 110c. The third ends 110c are connected to the trunk region 116 and respectively adjacent to the first ends 110a. A second through hole 11b is formed by joining the curved part 114 and the trunk region 116.

As shown in FIG. 3 and FIG. 4B, therefore, the body 11 has a plurality the through holes penetrating the body 11 from the upper surface 11s1 to the lower surface 11s2. The through holes include the two first through holes 11a1, 11a2 and a second through hole 11b. The first through holes 11a1, 11a2 and the second through hole 11b penetrate the body 11 along a penetrating axial direction DAX parallel to the rotation axis AX0 of the body 11.

An inner surface of the second through hole 11b is formed by joining a first inner surface 11b1 and a second inner surface 11b2. The first inner surface 11b1 includes a planar surface, and the second inner surface 11b2 includes a curved surface. The first inner surface 11b1 is closer to the first through holes 11a1, 11a2 than the second inner surface 11b2. The rotation axis AX0 of the body 11 passes through a center of mass C of the body 11 from the upper surface 11s1 to the lower surface 11s2. In other embodiments, the curved surface of the second inner surface may be formed by connecting a plurality of planes, and it means that the curved surface of the second inner surface is approximated by polygons, so the second inner surface is not limited to a single curved surface.

In this embodiment, a thickness of the annular part 111 along the penetrating axial direction DAX is greater than a thickness of the central part 112 along the penetrating axial direction DAX, and that is a thickness of the T-shaped part 113 along the penetrating axial direction DAX and a thickness of the curved part 114 along the penetrating axial direction DAX are both less than the thickness of the annular part 111 along the penetrating axial direction DAX. Thereby, a structural strength of the annular part 111 may be maintained, and the annular part 111 may have greater rigidity. When a plurality of jaws apply a clamping force to the body 11, the central part 112 may produce a greater radial deformation, thereby making the clamping force sensing apparatus 100 may have a higher measurement sensitivity. In other embodiments, the thickness of the annular part 111 may be substantially equal to the thickness of the central part 112.

As shown in FIG. 3 and FIG. 4C, the rotation axis AX0, the first axis line AX1 and the second axis line AX2 are orthogonal to one another. The first axis line AX1 passes through the second through hole 11b and is located between the two first through holes 11a1, 11a2. Also, the first axis line AX1 passes through the branch region 117, the trunk region 116 and the curved part 114. The second axis line AX2 does not cross the two first through holes 11a1, 11a2 and the second through hole 11b. Also, the second axis line AX2 passes through the trunk region 116. The first through hole 11a1 and the first through hole 11a2 are symmetrically located on opposite sides of the first axis line AX1 and are mirror-symmetric about the first axis line AX1. The second through hole 11b is symmetric with respect to the first axis line AX1. The T-shaped part 113 is symmetric with respect to the first axis line AX1. The curved part 114 is symmetric with respect to the first axis line AX1. Thereby, the rotation axis AX0 passes through not only the centroid C0 of the annular part 111 but also the center of mass C of the body 11. In another embodiment, the rotation axis AX0 passes through not only the centroid of the peripheral side surface 11s3 of the body 11 but also the center of mass C of the body 11.

The body 11 has a first load-bearing point 1101, a second load-bearing point 1102, a third load-bearing point 1103 and a fourth load-bearing point 1104 located on the peripheral side surface 11s3. A central angle θ1 defined by the centroid C0, the first load-bearing point 1101 and the second load-bearing point 1102 with respect to the rotation axis AX0 is 180 degrees. A central angle θ2 defined by the centroid C0, the first load-bearing point 1101 and the third load-bearing point 1103 with respect to the rotation axis AX0 is 120 degrees. A central angle θ3 defined by the centroid C0, the third load-bearing point 1103 and the fourth load-bearing point 1104 with respect to the rotation axis AX0 is 120 degrees. A central angle θ4 defined by the centroid C0, the first load-bearing point 1101 and the fourth load-bearing point 1104 with respect to the rotation axis AX0 is 120 degrees.

A connecting line L1 from the first load-bearing point 1101 to the rotation axis AX0 is located between the two first through holes 11a1, 11a2 . A connecting line L2 from the second load-bearing point 1102 to the rotation axis AX0 crosses the second through hole 11b. Each of a connecting line L3 from the third load-bearing point 1103 to the rotation axis AX0 and a connecting line L4 form the fourth load-bearing point 1104 to the rotation axis AX0 also respectively crosses the second through hole 11b.

In this embodiment, the strain sensors 121, 122 are disposed on the lower surface 11s2 of the body 11, but the disclosure is not limited thereto. In other embodiments, the strain sensors 121, 122 may be also disposed on the upper surface 11s1 of the body 11.

In this embodiment, the strain sensors 121, 122 may be disposed on the trunk region 116 and located between the surface 116a of the trunk region 116 connected with the branch region 117 and the second axis line AX2. As shown in the left half of FIG. 4C, the strain sensor 121 (or more than one strain sensor in another embodiment) is located between the first through hole 11a1 and the first inner surface 11b1 of the second through hole 11b, and the second axis line AX2 is located between the strain sensor 121 and the second through hole 11b. That is, the strain sensor 121 is disposed on a region located between the first through hole 11a1 and the first inner surface 11b1 in the lower surface 11s2 . Also, the strain sensor 121 may measure a first strain value in the first measuring axial direction SD1 and a second strain value in the second measuring axial direction SD2, wherein an angle between the first measuring axial direction SD1 and the second axis line AX2 is 45 degrees, and another angle between the second measuring axial direction SD2 and the second axis line AX2 is 135 degrees.

In addition, as shown in the right half of FIG. 4C. the strain sensor 122 (or more than one strain sensor in another embodiment) is located between the first through hole 11a2 and the first inner surface 11b1 of the second through hole 11b, and the second axis line AX2 is located between the strain sensor 122 and the second through hole 11b. That is, the strain sensor 122 is disposed on a region located between the first through hole 11a2 and the first inner surface 11b1 in the lower surface 11s2. Also, the strain sensor 122 may measure a first strain value in the first measuring axial direction SD1 and a second strain value in the second measuring axial direction SD2, wherein an angle between the first measuring axial direction SD1 and the second axis line AX2 is 45 degrees, and another angle between the second measuring axial direction SD2 and the second axis line AX2 is 135 degrees. In this embodiment, an angle between the first measuring axial direction SD1 and the second measuring axial direction SD2 may be 90 degrees (i.e. 135 degrees minus 45 degrees), but the disclosure is not limited thereto. In this embodiment, the first strain values and the second strain values measured by the strain sensor 121 or the strain sensor 122 may have different signs, either positive or negative. In this way, the strain sensor 121 or the strain sensor 122 may be electrically connected to a Wheatstone bridge which may use a differential measurement method to increase a sensitivity of the strain sensor 121 or the strain sensor 122 and to reduce an interference of noise.

Furthermore, as shown in FIG. 3 and FIG. 4D, in this embodiment, the first through holes 11a1 has a first centroid C11, the first through hole 11a2 has a first centroid C12, and the second through hole 11b has a second centroid C2. A first distance D11 from the first centroid C11 to the second axis line AX2 is greater than a second distance D2 from the second centroid C2 to the second axis line AX2. A first distance D12 from the first centroid C12 to the second axis line AX2 is greater than the second distance D2 from the second centroid C2 to the second axis line AX2. In the case, the first distances D11, D12 and the second distance D2 substantially extend along a direction parallel to the first axis line AX1. In this way, the rotation axis AX0 may pass through not only the center of mass C of the body 11 but also the centroid C0 of the annular part 111. Additionally, a projecting area of each of the first through holes 11a1, 11a2 in the penetrating axial direction DAX is the first projecting area A1, and a projecting area of the second through hole 11b in the penetrating axial direction DAX is the second projecting area A2. In this embodiment, the first projecting area A1 is less than the second projecting area A2, and twice the first projecting area A1 is less than the second projecting area A2. When each of the first distances D11, D12 is greater than the second distance D2, the rotation axis AX0 passes through not only the center of mass C of the body 11 but also the centroid C0 of the annular part 111. Accordingly, when a cutting machine with a plurality of jaws performs high-speed cutting, the clamping force sensing apparatus 100 clamped by the jaws may not experience a decrease in measurement accuracy of the clamping force sensing apparatus 100 or structural damage of the clamping force sensing apparatus 100 due to the imbalance of centrifugal force.

A two-point clamping strain value is an average value of strain values output by the strain sensors 121, 122 under a first radial force F1 applied to the first load-bearing point 1101 and a second radial force F2 applied to the second load-bearing point 1102 of the body 11 (the first radial force F1 and the second radial force F2, both of equal magnitude, are applied to the body 11). A three-point clamping strain value is another average value of the strain values output by the strain sensors 121, 122 under the first radial force F1 applied to the first load-bearing point 1101, the third radial force F3 applied to the third load-bearing point 1103 and the fourth radial force F4 applied to the fourth load-bearing point 1104 of the body 11 (the first radial force F1, the third radial force F3 and the fourth radial force F4, all of equal magnitude, are applied to the body 11). The magnitudes of the first radial force F1, the second radial force F2, the third radial force F3 and the fourth radial force F4 are set to be equal. A difference between the two-point clamping strain value and the three-point clamping strain value is less than a predetermined value. In this embodiment, the predetermined value is 15% of the three-point clamping strain value or 15% of the two-point clamping strain value.

Since the three-point clamping strain value is caused by three radial forces, and the two-point clamping strain value is caused by two radial forces. Therefore, if the body 11 does not have the first through holes 11a1, 11a2 and the second through hole 11b, there will be a large difference between the three-point clamping strain value and the two-point clamping strain value (for example, the three-point clamping strain value is 1.5 times the two-point clamping strain value) when the first radial force F1 and the second radial force F2 are applied, as well as when the first radial force F1, the third radial force F3 and the fourth radial force F4 are applied. In other words, if the body 11 does not have the first through holes 11a1, 11a2 and the second through hole 11b, the clamping force sensing apparatus 100 may not have the dual functions of accurately measuring a clamping force of a double-jaw clamp 200 and accurately measuring a clamping force of the clamping force of the triple-jaw clamp 300.

In this embodiment, since twice the first projecting area A1 of each of the first through holes 11a1, 11a2 is less than the second projecting area A2 of the second through hole 11b, so that an area of upper half of the central part 112 (a portion of the central part above the second axis line AX2) is greater than an area of lower half of the central part 112 (a portion of the central part below the second axis line AX2), thereby the difference between the three-point clamping strain value and the two-point clamping strain value may be reduced. Furthermore, in this embodiment, since each of the first distances D11, D12 is greater than the second distance D2, so that an area of the trunk region 116 may be greater than an area of the curved part 114. Accordingly, the difference between the three-point clamping strain value and the two-point clamping strain value may be further reduced. In this way, the clamping force sensing apparatus 100 may have the dual functions of measuring the clamping force of the double-jaw clamp 200 and measuring the clamping force of the triple-jaw clamp 300.

As shown in FIG. 5, the chucks 131, 133, 134 may be screwed and fixed to the annular part 111 of the body 11 and respectively located on the first load-bearing point 1101, the third load-bearing point 1103 and the fourth load-bearing point 1104 of the peripheral side surface 11s3. The chuck 131 is closer to the first through holes 11a1, 11a2 than the other chucks 133, 134. The chuck 131 is farther from the second through hole 11b than the other chucks 133, 134. The chuck 131 is penetrated by the first axis line AX1. Furthermore, the chuck 131 is closer to the branch region 117 of the T-shaped part 113 than the other chucks 133, 134. The chuck 131 is farther from the curved part 114 than the other chucks 133, 134. The central angle θ2 defined by the chuck 131 and the chuck 133 with respect to the rotation axis AX0 is 120 degrees. The central angle θ3 defined by the chuck 133 and the chuck 134 with respect to the rotation axis AX0 is 120 degrees. The central angle θ4 defined by the chuck 131 and the chuck 134 with respect to the rotation axis AX0 is 120 degrees. When the clamping force of the triple-jaw clamp 300 is to be measured as shown in FIG. 1, the three jaws 301 may respectively be against the three chucks 131, 133, 134 to clamp the clamping force sensing apparatus 100.

As shown in FIG. 2, FIG. 3 and FIG. 4A, the circuit module 14, the circuit container 15 and the power source 16 are disposed on the upper surface 11s1 of the body 11. The circuit module 14 is electrically connected to the strain sensors 121, 122. The power source 16 is electrically connected to the circuit module 14. The circuit container 15 has a containing groove 15a. The containing groove 15a contains the circuit module 14 and the power source 16. The circuit container 15 is fixed to the body 11. The switch 17 is disposed on the circuit module 14. The front plate 18 is disposed on the circuit container 15. The first fixing components 101 penetrate the front plate 18 and the circuit container 15 to screw and fix the front plate 18 and the circuit container 15 to screw holes 11c located at the fixing parts 1151, 1152 and screw holes 11c located at the curved part 114 of the body 11. The circuit module 14 and the power source 16 are sandwiched between the body 11 and the circuit container 15. The circuit container 15 is sandwiched between the body 11 and the front plate 18. The back plate 19 is disposed on the lower surface 11s2 of the body 11. The switch 17 may penetrate the circuit container 15 and the front plate 18 and be exposed by the front plate 18. A portion of the circuit module 14 may also be exposed by the front plate 18. The second fixing components 102 penetrate the back plate 19 to screw and fix the back plate 19 to the screw holes 11c located at the fixing parts 1151, 1152 and the screw holes 11c located at the curved part 114 of the body 11.

As shown in FIG. 5, a first radial force F1 applied to the first load-bearing point 1101 by the chuck 131 may be transmitted to the strain sensors 121, 122 through the T-shaped part 113. Since each of the connecting line L3 from the third load-bearing point 1103 to the rotation axis AX0 and the connecting line L4 from the fourth load-bearing point 1104 to the rotation axis AX0 crosses the second through hole 11b, a third radial force F3 applied to the third load-bearing point 1103 by the chuck 133 and the fourth radial force F4 applied to the fourth load-bearing point 1104 by the chuck 134 have to pass through the curved part 114 and to bypass the second through hole 11b so as to reach the strain sensors 121, 122 through the T-shaped part 113. More specifically, since each of the connecting line L3 from the third load-bearing point 1103 to the rotation axis AX0 and the connecting line L4 from the fourth load-bearing point 1104 to the rotation axis AX0 crosses the second through hole 11b, so that an angle θ5 between two connecting lines from two ends 11b3 of the second through hole 11b to the rotation axis AX0 is greater than 120 degrees. Therefore, when the first load-bearing point 1101 and the second load-bearing point 1102 respectively bear the first radial force F1 and the second radial force F2, the second radial force F2 also has to pass through the curved part 114 and to bypass the second through hole 11b so as to reach the strain sensors 121, 122 through the T-shaped part 113. Since all of the second radial force F2, the third radial force F3 and the fourth radial force F4 have to pass through the curved part 114 and to bypass the second through hole 11b so as to reach the strain sensors 121, 122 through the T-shaped part 113. Therefore, as described in paragraph [0030], the difference between the two-point clamping strain value and the three-point clamping strain value is less than a predetermined value when the magnitudes of the first radial force F1, the second radial force F2, the third radial force F3 and the fourth radial force F4 are equal. In this way, the clamping force sensing apparatus 100 may have the dual functions of measuring the clamping force of the double-jaw clamp 200 and measuring the clamping force of the triple-jaw clamp 300.

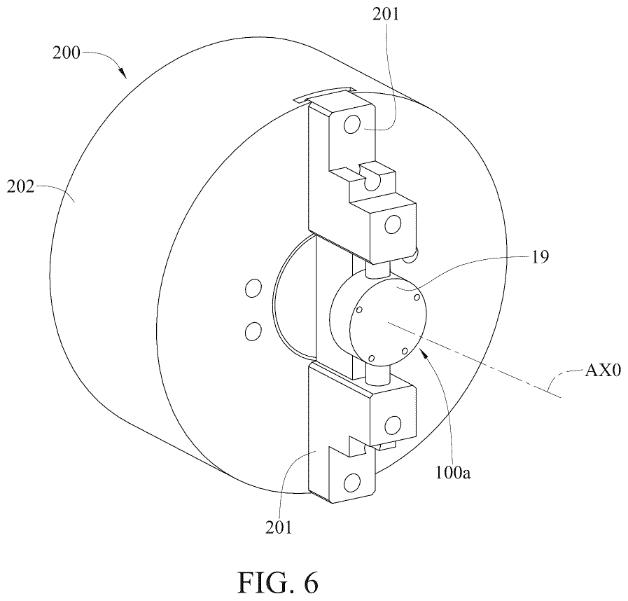

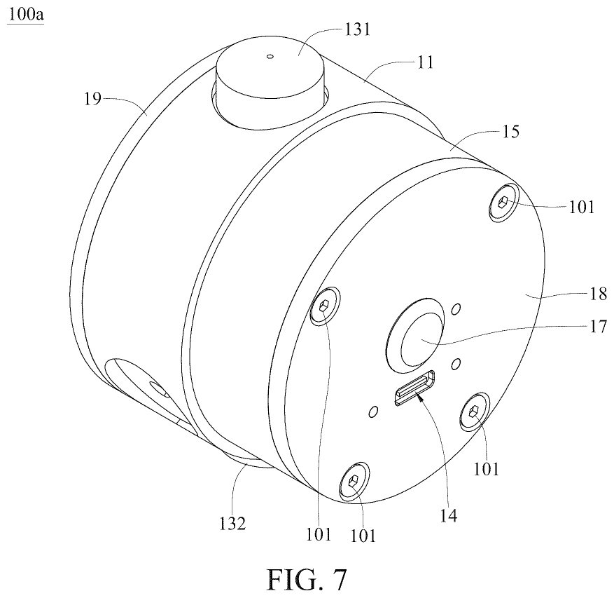

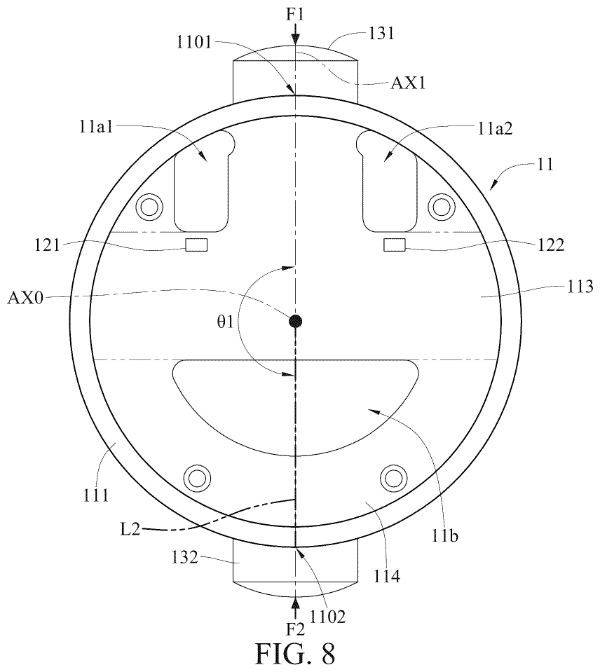

Please refer to FIG. 6 to FIG. 8. FIG. 6 illustrates a schematic three-dimensional view of a double-jaw clamp using a clamping force sensing apparatus according to another embodiment of the disclosure. FIG. 7 illustrates a schematic three-dimensional view of the clamping force sensing apparatus in FIG. 6. FIG. 8 illustrate a schematic rear view of a portion of the clamping force sensing apparatus in FIG. 7.

As shown in FIG. 6, the double-jaw clamp 200 includes two jaws 201 an a chuck plate 202. The chuck plate 202 has a rotation axis AX0. The jaws 201 may approach the rotation axis AX0 to clamp an object or may move away from the rotation axis AX0 to release the object. When a clamping force of the double-jaw clamp 200 is to be measured, the clamping force sensing apparatus 100a is placed between the two jaws 201 and clamped by the two jaws 201. In FIG. 6, the back plate 19 of the clamping force sensing apparatus 100a may be faced away from the chuck plate 202, but the disclosure is not limited thereto. In other embodiments, the back plate 19 of the clamping force sensing apparatus 100a may be faced to the chuck plate 202.

As shown in FIG. 7 and FIG. 8, the clamping force sensing apparatus 100 of this embodiment is similar to the clamping force sensing apparatus 100 shown in FIG. 2 to FIG. 5. The difference is that the clamping force sensing apparatus 100a includes two chucks 131, 132. The chucks 131, 132 may be screwed and fixed to the annular part 111 of the body 11 and respectively located on the first load-bearing point 1101 and the second load-bearing point 1102 of the peripheral side surface 11s3. The chuck 131 is closer to the first through holes 11a1, 11a2 than the other chuck 132. The chuck 131 is farther from the second through hole 11b than the other chuck 132. In other words, the chuck 131 is closer to the branch region 117 of the T-shaped part 113 than the other chuck 132. The chuck 131 is farther from the curved part 114 than the other chuck 132. The chuck 132 is closer to the second through hole 11b than the other chuck 131. The chuck 132 is farther from the first through holes 11a1, 11a 2 than the other chuck 131. In other words, the chuck 132 is closer to the curved part 114 than the other chuck 131. The chuck 132 is farther from the branch region 117 of the T-shaped part 113 than the other chuck 131. Both of the chucks 131, 132 are penetrated by the first axis line AX1. The central angle θ1 defined by the chucks 131, 132 with respect to the rotation axis AX0 is 180 degrees. When the clamping force of the double-jaw clamp 200 is to be measured as shown in FIG. 6, the two jaws 201 may respectively be against the two chucks 131, 132 to clamp the clamping force sensing apparatus 100a.

As shown in FIG. 8, the first radial force F1 applied to the first load-bearing point 1101 by the chuck 131 may be transmitted to the strain sensors 121, 122 through the T-shaped part 113. Since the connecting line L2 from the second load-bearing point 1102 to the rotation axis AX0 crosses the second through hole 11b, the second radial force F2 applied to the second load-bearing point 1102 by the chuck 132 has to pass through the curved part 114 and to bypass the second through hole 11b so as to reach the strain sensors 121, 122 through the T-shaped part 113.

As shown in FIG. 5 and FIG. 8, either the clamping force sensing apparatus 100 applied to the triple-jaw clamp 300 or the clamping force sensing apparatus 100a applied to the double-jaw clamp 200, radial forces applied to the load-bearing points have to pass through the curved part 114 and to bypass the second through hole 11b so as to reach the strain sensors 121, 122 through the T-shaped part 113. This will result in the difference between the three-point clamping strain value of the clamping force sensing apparatus 100 and the two-point clamping strain value of the clamping force sensing apparatus 100a being less than 15% of the three-point clamping strain value or 15% of the two-point clamping strain value. Therefore, after simple adjustment of the number of the chucks 131, 132, 133, 134, the clamping force sensing apparatus 100 and the clamping force sensing apparatus 100a may easily be applied to measure the clamping force of the triple-jaw clamp 300 or measure the clamping force of the double-jaw clamp 200.

In addition, in the above-mentioned embodiments, although the clamping force sensing apparatus 100 is formed by installing the three chucks 131, 133, 134, or the clamping force sensing apparatus 100a is formed by installing the two chucks 131, 132, but the disclosure is not limited thereto. In other embodiments, the clamping force sensing apparatus may also include four chucks 131, 132, 133, 134 respectively located on the first load-bearing point 1101, the second load-bearing point 1102, the third load-bearing point 1103 and the fourth load-bearing point 1104 of the peripheral side surface 11s3. Thereby, the step of adjusting the number of the chucks 131, 132, 133, 134 may be omitted, and it may be directly applied to measuring the clamping force of the triple-jaw clamp 300 or measuring the clamping force of the double-jaw clamp 200.

As discussed above, in the clamping force sensing apparatus in one embodiment of the disclosure, the through holes in the body and the four load-bearing points are configured according to the central angles. Whether the clamping force sensing apparatus measures the clamping force of the triple-jaw clamp or the double-jaw clamp, the radial force applied to the first load-bearing point may be transmitted to the strain sensors through the T-shaped part. Meanwhile, the radial forces applied to the second, third and fourth load-bearing points all pass through the curved part and to bypass the second through hole so as to reach the strain sensors through the T-shaped part. Therefore, the difference between the two-point clamping strain value and the three-point clamping strain value of the clamping force sensing apparatus is less than 15% of the three-point clamping strain value or 15% of the two-point clamping strain value. Since the difference between the two-point clamping strain value and the three-point clamping strain value is small enough, the clamping force sensing apparatus may be applied to accurately measure the clamping force of different types, including the clamping force of the triple-jaw clamp and the clamping force of the double-jaw clamp, by calibrating the measured strain value.

Although the disclosure is disclosed in the foregoing embodiments, it is not intended to limit the disclosure. All variations and modifications made without departing from the spirit and scope of the disclosure fall within the scope of the disclosure. For the scope defined by the disclosure, please refer to the attached claims.

What is claimed is:

1. A clamping force sensing apparatus, comprising:
a body comprising:
two first through holes;
a second through hole; and
a peripheral side surface,
wherein the two first through holes and the second through hole penetrate the body along a penetrating axial direction parallel to a rotation axis, the rotation axis passes through a center of mass of the body and a centroid of the peripheral side surface, an inner surface of the second through hole is formed by joining a first inner surface and a second inner surface, the first inner surface is closer to the two first through holes than the second inner surface, and a first projecting area of each of the two first through holes in the penetrating axial direction is less than a second projecting area of the second through hole in the penetrating axial direction;
a plurality of strain sensors disposed on the body, wherein at least one of the plurality of strain sensors is located between one of the two first through holes and the first inner surface, and at least another of the plurality of strain sensors is located between the other of the two first through holes and the first inner surface; and
a plurality of chucks fixed to the body.

2. The clamping force sensing apparatus according to claim 1, wherein the first inner surface comprises a planar surface, and the second inner surface comprises a curved surface.

3. The clamping force sensing apparatus according to claim 1, wherein an angle between two connecting lines from two ends of the second through hole to the rotation axis is greater than 120 degrees.

4. The clamping force sensing apparatus according to claim 1, wherein the body comprises an annular part, the annular part is a circular ring with a ring center, the rotation axis and a first axis line are orthogonal to each other, the first axis line crosses the second through hole and is located between the two first through holes, the two first through holes are symmetrically located on opposite sides of the first axis line and are mirror-symmetric about the first axis line, and the second through hole is symmetric with respect to the first axis line.

5. The clamping force sensing apparatus according to claim 4, wherein the rotation axis, the first axis line and a second axis line are orthogonal to one another, the second axis line does not cross the two first through holes and the second through hole, each of the two first through holes has a first centroid, the second through hole has a second centroid, and a first distance from each of the two first centroids to the second axis line is greater than a second distance from the second centroid to the second axis line.

6. The clamping force sensing apparatus according to claim 4, wherein the rotation axis, the first axis line and a second axis line are orthogonal to one another, the second axis line does not cross the two first through holes and the second through hole, at least one of the plurality of strain sensors is disposed between one of the two first through holes and the second axis line, at least another of the plurality of strain sensors is disposed between the other of the two first through holes and the second axis line, each of the plurality of strain sensors measures a first strain value in a first measuring axial direction and a second strain value in a second measuring axial direction, an angle between the first measuring axial direction and the second axis line is 45 degrees, and another angle between the second measuring axial direction and the second axis line is 135 degrees.

7. The clamping force sensing apparatus according to claim 4, wherein a number of the plurality of chucks is two, the plurality of chucks are disposed on the body, the first axis line penetrates the plurality of chucks, and a central angle defined by the plurality of chucks with respect to the rotation axis is 180 degrees.

8. The clamping force sensing apparatus according to claim 4, wherein a number of the plurality of chucks is three, the plurality of chucks are disposed on the body, one of the plurality of chucks is closer to the two first through holes than the other chucks, the one of the plurality of chucks is farther from the second through hole than the other chucks, the one of the plurality of chucks is penetrated by the first axis line, and a central angle defined by any two of the plurality of chucks with respect to the rotation axis is 120 degrees.

9. The clamping force sensing apparatus according to claim 1, further comprising circuit module, a power source and a circuit container, wherein the circuit container is fixed to the body and has a containing groove, the circuit module and the power source are disposed inside the containing groove, and the circuit module is electrically connected to the plurality of strain sensors and the power source.

10. The clamping force sensing apparatus according to claim 1, wherein the body comprises an annular part and a central part located inside the annular part, and a thickness of the annular part is greater than a thickness of the central part.

11. A clamping force sensing apparatus, comprising:
a body, comprising:
an annular part;
a T-shaped part disposed inside the annular part, wherein the T-shaped part has a trunk region and a branch region, the trunk region has two first ends, the branch region extends from the trunk region and has a second end, the two first ends and the second end are respectively connected to the annular part, two first through holes are formed by joining the trunk region, the branch region and the annular part, and the two first through holes are respectively located at two opposite sides of the branch region; and
a curved part disposed inside the annular part, wherein the curved part is curved along the annular part and connected to the annular part, the curved part has two third ends, the two third ends are connected to the trunk region and respectively adjacent to the two first ends, and a second through hole is formed by the curved part and the trunk region;
wherein the two first through holes and the second through hole penetrate the body along a penetrating axial direction parallel to a rotation axis of the body, the rotation axis passes through a center of mass of the body and a centroid of the annular part;
a plurality of strain sensors disposed on the trunk region; and
a plurality of chucks fixed to the annular part.

12. The clamping force sensing apparatus according to claim 11, wherein an angle between two connecting lines from two ends of the second through hole to the rotation axis is greater than 120 degrees.

13. The clamping force sensing apparatus according to claim 11, wherein the annular part is a circular ring with a ring center, the rotation axis and a first axis line are orthogonal to each other, the first axis line crosses the second through hole and is located between the two first through holes, the two first through holes are symmetrically located on opposite sides of the first axis line and are mirror-symmetric about the first axis line, and the second through hole is symmetric with respect to the first axis line.

14. The clamping force sensing apparatus according to claim 13, wherein the rotation axis, the first axis line and a second axis line are orthogonal to one another, the second axis line is does not cross the two first through holes and the second through hole, each of the two first through holes has a first centroid, the second through hole has a second centroid, and a first distance from each of the two first centroids to the second axis line is greater than a second distance from the second centroid to the second axis line.

15. The clamping force sensing apparatus according to claim 13, wherein the rotation axis, the first axis line and a second axis line are orthogonal to one another, the second axis line does not cross the two first through holes and the second through hole, at least one of the plurality of strain sensors is disposed between one of the two first through holes and the second axis line, at least another of the plurality of strain sensors is disposed between the other of the two first through holes and the second axis line, each of the plurality of strain sensors measures a first strain value in a first measuring axial direction and a second strain value in a second measuring axial direction, an angle between the first measuring axial direction and the second axis line is 45 degrees, and another angle between the second measuring axial direction and the second axis line is 135 degrees.

16. The clamping force sensing apparatus according to claim 11, wherein the rotation axis, a first axis line and a second axis line are orthogonal to one another, the first axis line passes through the branch region, the trunk region and the curved part, the second axis line passes through the trunk region, the T-shaped part is symmetric with respect to the first axis line, the curved part is symmetric with respect to the first axis line, the branch region extends from a surface of the trunk region, and the plurality of strain sensors are located between the surface and the second axis line.

17. The clamping force sensing apparatus according to claim 16, wherein a number o f the plurality of chucks is two, the two chucks are disposed on the annular part, the first axis line penetrates the two chucks, and a central angle of the two chucks with respect to the rotation axis is 180 degrees.

18. The clamping force sensing apparatus according to claim 16, wherein a number of the plurality of chucks is three, the plurality of chucks are disposed on the annular part, one of the plurality of chucks is closer to the branch region of the T-shaped part than the other chucks, the one of the plurality of chucks is farther from the curved part than the other chucks, the one of the plurality of chucks is penetrated by the first axis line, and a central angle defined by any two of the plurality of chucks with respect to the rotation axis is 120 degrees.

19. The clamping force sensing apparatus according to claim 11, further comprising circuit module, a power source and a circuit container, wherein the circuit container is fixed to the body and has a containing groove, the circuit module and the power source are disposed inside the containing groove, and the circuit module is electrically connected to the plurality of strain sensors and the power source.

20. The clamping force sensing apparatus according to claim 11, wherein a thickness of the T-shaped part and a thickness of the curved part are both less than a thickness of the annular part.

21. A clamping force sensing apparatus, comprising:
a body being a column, wherein the body has a peripheral side surface, an upper surface and a lower surface and has a first load-bearing point, a second load-bearing point, a third load-bearing point and a fourth load-bearing point located on the peripheral side surface;
a plurality of strain sensors disposed on the upper surface or the lower surface of the body; and
a plurality of chucks fixed to at least two of the first load-bearing point, the second load-bearing point, the third load-bearing point and the fourth load-bearing point of the body;
wherein a rotation axis of the body passes through a centroid of the peripheral side surface from the upper surface to the lower surface, a central angle defined by the centroid, the first load-bearing point and the second load-bearing point with respect to the rotation axis is 180 degrees, a central angle defined by the centroid, any two of the first load-bearing point, the third load-bearing point and the fourth load-bearing point with respect to the rotation axis is 120 degrees;
wherein a two-point clamping strain value is an average value of strain values output by the plurality of strain sensors under a radial force applied to each of the first load-bearing point and the second load-bearing point;
wherein, a three-point clamping strain value is another average value of the strain values output by the plurality of strain sensors under another radial force applied to each of the first load-bearing point, the third load-bearing point and the fourth load-bearing point, and a magnitude of the radial force is equal to a magnitude of the another radial force;
wherein the body has a plurality of through holes penetrating the body from the upper surface to the lower surface along a penetrating axial direction parallel to the rotation axis, the plurality of through holes are configured such that the rotation axis passes through a center of mass of the body, and a difference between the two-point clamping strain value and the three-point clamping strain value is less than a predetermined value.

22. The clamping force sensing apparatus according to claim 21, wherein the predetermined value is 15% of the three-point clamping strain value or 15% of the two-point clamping strain value.

23. The clamping force sensing apparatus according to claim 21, wherein the plurality of through holes comprise two first through holes and a second through hole, the body comprises an annular part being a circular ring with a ring center, the rotation axis and a first axis line are orthogonal to each other, the first axis line crosses the second through hole and is located between the two first through holes, the two first through holes are symmetrically located on opposite sides of the first axis line and are mirror-symmetric about the first axis line, and the second through hole is symmetric with respect to the first axis line.

24. The clamping force sensing apparatus according to claim 23, wherein an angle between two connecting lines from two ends of the second through hole to the rotation axis is greater than 120 degrees.

25. The clamping force sensing apparatus according to claim 23, wherein the rotation axis, the first axis line and a second axis line are orthogonal to one another, the second axis line does not cross the two first through holes and the second through hole, each of the two first through holes has a first centroid, the second through hole has a second centroid, and a first distance from each of the two first centroids to the second axis line is greater than a second distance from the second centroid to the second axis line.

26. The clamping force sensing apparatus according to claim 23, wherein the rotation axis, the first axis line and a second axis line are orthogonal to one another, the second axis line does not cross the two first through holes and the second through hole, at least one of the plurality of strain sensors is disposed between one of the two first through holes and the second axis line, at least another of the plurality of strain sensors is disposed between the other of the two first through holes and the second axis line, each of the plurality of strain sensors measures a first strain value in a first measuring axial direction and a second strain value in a second measuring axial direction, an angle between the first measuring axial direction and the second axis line is 45 degrees, and another angle between the second measuring axial direction and the second axis line is 135 degrees.

27. The clamping force sensing apparatus according to claim 21, wherein the plurality of through holes comprise two first through holes and a second through hole, at least one of the plurality of strain sensors is located between one of the two the first through holes and the second through hole, at least another of the plurality of strain sensors is located between the other of the two first through holes and the second through hole, a connecting line from the first load-bearing point to the rotation axis is located between the two first through holes, a connecting line from the second load-bearing point to the rotation axis crosses the second through hole.

28. The clamping force sensing apparatus according to claim 27, wherein a connecting line from the third load-bearing point to the rotation axis and a connecting line from the fourth load-bearing point to the rotation axis both cross the second through hole.
